(19) United States
(12) Patent Application Publication
(10) Pub. No.: US 2007/0263328 A1
(43) Pub. Date: Nov. 15, 2007

(54) Circuit including a superconducting element and a switch, a system including the circuit, and a method of using the system

(75) Inventors: Philip A. Jonas, Delmar, NY (US); Ronald E. Hintz, Corinth, NY (US); Robert E. Wilcox, Westerlo, NY (US); Michael Frantsov, Albany, NY (US); John R. Rogers, Burnt Hills, NY (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: Intermagnetics General Corporation, Latham, NY (US)

(21) Appl. No.: 11/430,662

(22) Filed: May 9, 2006

(51) Int. Cl. H02H 7/00

(52) U.S. Cl. 361/19

(57) ABSTRACT

A switch can be used in conjunction with a superconducting current path to provide a more reliable circuit and system. The switch can be connected in parallel with a portion of the superconducting current path. In one embodiment, the switch may be connected in parallel with an entire superconducting element, such as a persistent current switch, a superconducting coil, or the like, or may be connected in parallel across only a portion of a superconducting element. A method of using the system is also disclosed.

### BACKGROUND

1. Field of the Disclosure

The disclosure relates to circuits, systems, and methods, and more particularly to circuits including superconducting elements and switches, systems including the circuits, and methods of using the systems.

2. Description of the Related Art

FIG. 1 includes a circuit schematic of a portion of a magnetic resonance imaging (“MRI”) system 100. The MRI system 100 includes a superconducting current path 120 that includes a portion of a persistent current switch 122 and superconducting coils 124, 126, and 128. The persistent current switch 122 includes a superconducting element 1222, which is part of the superconducting current path, and a resistive heating element 1224, which is not part of the superconducting current path. All of the circuit elements as illustrated in FIG. 1 lie within a vessel that can include a liquid cryogen.

When the superconducting coils 124, 126, and 128 are being taken to their specified or desired magnetic field, external power supply terminals (not illustrated) are connected to power supply terminals 142 and 144. The persistent current switch 122 is placed into its higher impedance state, which can be achieved by activating the resistive heating element 1224 to substantially prevent the superconducting element 1222 from reaching a superconducting state. Current flows from one of the external power supply terminals through one of the power supply terminals (142 or 144), through the superconducting coils 124, 126, and 128, through the other of the power supply terminals (142 or 144), and to the other external power supply terminal. After the superconducting coils 124, 126, and 128 reach the specified or desired magnetic field, the persistent current switch is taken to its lower impedance state, which is achieved by deactivating the resistive heating element 1224. As the temperature decreases, the superconducting element 1222 reaches its superconducting state, and the external power supply terminals can then be removed from the power supply terminals 142 and 144. In theory, the superconducting circuit path should be able to sustain current flow and keep the magnetic fields produced by the superconducting coils 124, 126, and 128 into perpetuity. In practice, the current flow and magnetic fields should be able to be maintained for at least a year without having to reconnect the MRI system 100 to the external power source or having to provide additional liquid cryogen.

The persistent current switch 122 can have reliability that is insufficient for the MRI system 100 to reliably operate for long periods of time. Even though the resistive heating element 1224 may remain deactivated, the superconducting element 1222 may not remain in its superconducting state. The superconducting element 1222 becomes resistive when it is not is its superconducting state, and causes current within the superconducting current path 120 to become reduced and produces heat within the vessel 110. If a liquid cryogen is used, the heat can cause substantially all of the liquid cryogen to rapidly boil off. The boiling-off of the liquid cryogen can require recharging of the vessel 110 with expensive liquid cryogen and recooling the system. The presence of a resistance in the superconducting current path will cause the current to decay, thus, causing a reduction in magnetic field.

Many MRI systems, such as the MRI system 100 in FIG. 1, are installed at remote locations that do not have qualified service technicians. A qualified service technician may need to travel to reach the remote location; however, by the time the qualified service technician reaches the remote location, the cryogen loss will have already occurred.

### BRIEF DESCRIPTION OF THE DRAWINGS

The present disclosure may be better understood, and its numerous features and advantages made apparent to those skilled in the art by referencing the accompanying drawings.

FIG. 1 includes a circuit drawing of a magnetic resonance imaging system. (Prior art)

FIG. 2 includes a circuit diagram of a system that includes a switch that can be used to bypass a portion of a superconducting circuit path.

FIG. 3 includes a circuit diagram of a system that includes alternative embodiments of switches that can be used to bypass portions of a superconducting circuit path.

FIGS. 4 and 5 include schematic drawings of the system corresponding to the circuit in FIG. 2.

FIG. 6 includes a flow diagram of a method of operating the system of FIGS. 4 and 5.

FIGS. 7 through 9 include a flow diagram regarding details of the method in FIG. 6.

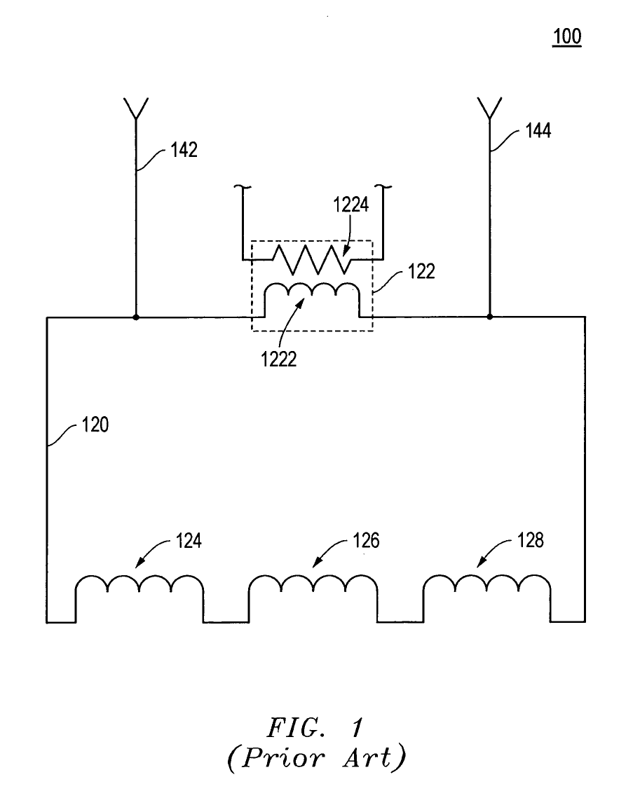

The use of the same reference symbols in different drawings indicates similar or identical items. Skilled artisans will appreciate that elements in the figures are illustrated for simplicity and clarity and have not necessarily been drawn to scale.

### DETAILED DESCRIPTION

A switch can be used in conjunction with a superconducting current path to provide a more reliable circuit and system. The switch can be connected in parallel with a portion of the superconducting current path. In one embodiment, the switch may be connected in parallel with an entire superconducting element, such as a persistent current switch, a superconducting coil, or the like, or may be connected in parallel across only a portion of a superconducting element.

A method of using a system can include coupling a first external power supply terminal to a first power supply terminal of the system, coupling a second external power supply terminal to a second power supply terminal of the system, and flowing current through a superconducting element within the system when the first external power supply terminal to the first power supply terminal of the system and the second external power supply terminal to the second power supply terminal of the system. The method can also include placing a persistent current switch of the system into a first lower impedance state, decoupling the first external power supply terminal from the first power supply terminal of the system, decoupling the second external power supply terminal from the second power supply terminal of the system, and placing a first switch of the system into a second lower impedance state.

A few terms are defined or clarified to aid in understanding of the terms as used throughout this specification.

As used herein, a switch is characterized as having a higher impedance state and a lower impedance state. The higher impedance state can be an open circuit or a closed circuit in which resistance or other impedance through the switch is substantially higher than the lower impedance state. The lower impedance state can be a closed circuit in which the resistance or other impedance is substantially lower than the higher impedance state. For example, the higher impedance state of the switch can be at least three orders of magnitude higher in resistance as compared to the lower impedance state of the same switch.

The term “control element,” when referring to a switch, is intended to mean a circuit element or an object that is capable of changing the switch from a lower impedance state to a higher impedance state, from the higher impedance state to the lower impedance state, or both.

The term “faulting state” is intended to mean a state in which a superconducting element along a superconducting current path is not in a superconducting state.

The term “mechanical switch” is intended to mean a switch having a moving part that is used to change the switch from a lower impedance state to a higher impedance state, from the higher impedance state to the lower impedance state, or both. For the purposes of this specification, a mechanical switch can include a knife switch, an electromechanical relay, etc.

The term “persistent current switch” is intended to mean a switch capable of latching into a state and remaining in such state, after power to a control element of the switch is removed.

The term “superconducting” is intended to describe a material capable of achieving a substantially zero resistance at a critical temperature, and can include low-temperature superconductors, high-temperature superconductors, boride-based superconductors, etc.

The term “superconducting current path” is intended to mean a circuit path that is capable of allowing current to flow at nearly zero resistance. A circuit path that includes significantly higher resistance, such as through a non-superconducting portion of a switch when the switch is in a lower impedance state, is not part of a superconducting circuit path.

The term “superconducting element” is intended to mean a circuit element or an object that has substantially zero resistance when in its superconducting state.

The term “typical operating state” is intended to mean a state in which all superconducting elements along a superconducting current path are in their superconducting states.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, for clarity purposes and to give a general sense of the scope of the embodiments described herein, the use of the “a” or “an” are employed to describe one or more articles to which “a” or “an” refers. Therefore, the description should be read to include one or at least one whenever “a” or “an” is used, and the singular also includes the plural unless it is clear that the contrary is meant otherwise.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety. In case of conflict, the present specification, including definitions, will control. In addition, the materials, methods, and examples are illustrative only and not intended to be limiting.

To the extent not described herein, many details regarding specific materials, processing acts, and components, assemblies, and systems are conventional and may be found in textbooks and other sources within the superconducting, cryogenic, and medical device arts.

While much of the description herein is directed to an MRI system, after reading this specification, skilled artisans will appreciate that the concepts described herein may also be extended to a different system. In another embodiment, the system may include a superconducting element in a different application (e.g., a transmission or distribution cable, a transformer, a fault current limiter, one or more other suitable electronic devices, or any combination thereof). Thus, the systems and methods described herein are not limited only for use with an MRI system.

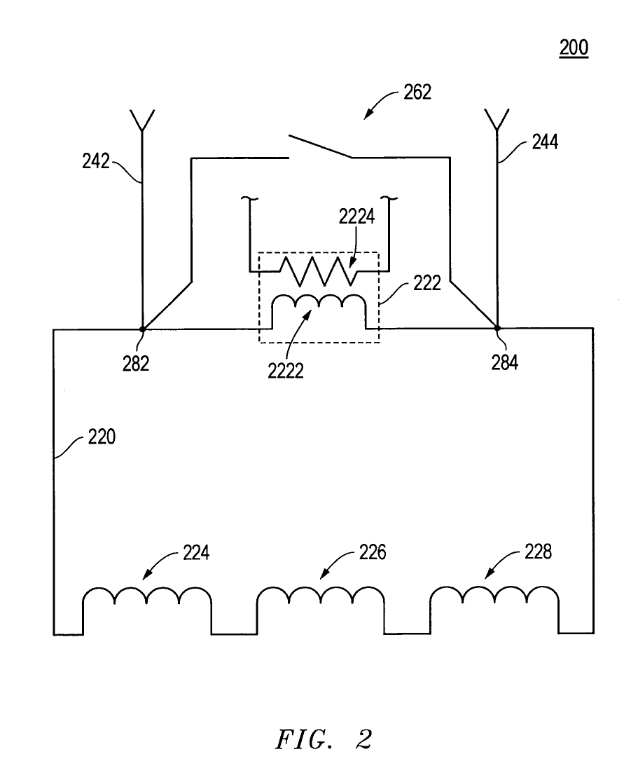

FIG. 2 includes a circuit schematic of a system 200. In one embodiment, the system 200 can be an MRI system. The system 200 includes a superconducting current path 220 that includes a portion of a persistent current switch 222 superconducting coils 224, 226, and 228. The persistent current switch 222 includes a superconducting element 2222, which is part of the superconducting circuit path, and a control element 2224, which is not part of the superconducting circuit path. In one embodiment, the control element 2224 can include a resistive heating element, and in another embodiment, the control element 2224 may include another electrical or physical element that allows the persistent current switch to be placed into its lower impedance state, its higher impedance state, or both. The control element 2224 may be controlled by a controller or other electronic circuits (not illustrated). Although not illustrated, more or fewer superconducting coils or persistent current switches, other superconducting elements, a gradient coil, a control sub-system, another sub-system, or any combination thereof may also be used.

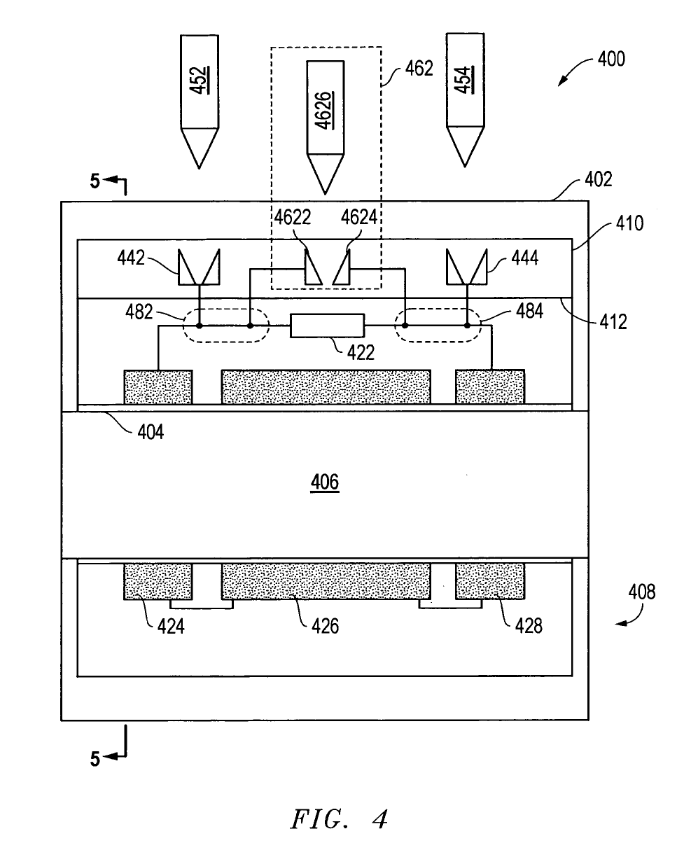

The system 200 further includes a switch 262 that is connected in parallel with a portion of the superconducting current path 220. In the embodiment as illustrated in FIG. 2, the switch has one terminal that is connected to a node 282 and another terminal connected to a node 284. Physical embodiments of the switch 262 are described in more detail with respect to FIG. 4.

The persistent current switch 222 also has a terminal connected to the node 282 and another terminal connected to the node 284, the power supply terminal 242 is connected to the node 282, and the power supply terminal 244 is connected to the node 284. In one embodiment, the switch 262 includes a current-carrying portion that does not include a superconducting element. Another current-carrying portion of the switch 262 may or may not include a superconducting element, such as a superconducting wire, tape, or solder. A terminal of the superconducting coil 224 is coupled to the node 282, and a terminal of the superconducting coil 228 is coupled to the node 284, and in a particular embodiment, the terminal of the superconducting coil 224 is connected to the node 282, and a terminal of the superconducting coil 228 is connected to the node 284. The superconducting coils 224, 226, and 228 are coupled to each other, and in a particular embodiment, superconducting coil 224 is connected to the superconducting coil 226, which is connected to the superconducting coil 228. In another particular embodiment, a circuit element (not illustrated) may lie (1) between (i) the node 282 and (ii) the power supply terminal 242, the persistent current switch 222, the switch 262, the superconducting coil 224, or any combination thereof, (2) between (i) the node 284 and (ii) the power supply terminal 244, the persistent current switch 222, the switch 262, the superconducting coil 228, or any combination thereof, (3) between each immediately adjacent pair of superconducting coils (224, 226, 228), or any combination of (1), (2), and (3). The circuit element may or may not be a superconducting element.

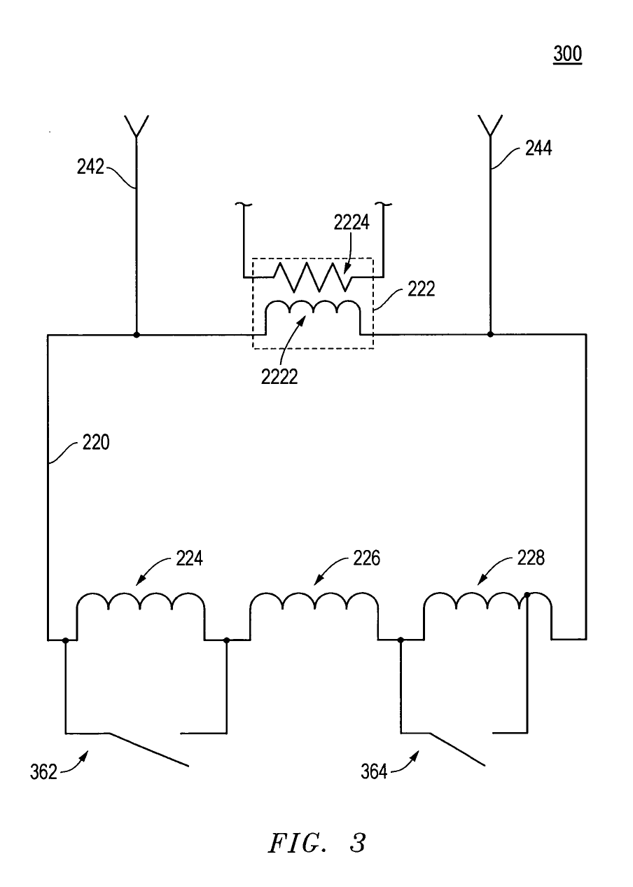

FIG. 3 includes a circuit schematic of a system 300 to illustrate other locations in the circuit in which a switch may be used. In one embodiment, a switch 362 may be connected in parallel with a superconducting coil, such as superconducting coil 224. In another embodiment, a switch 364 may be connected in across only a portion of a superconducting element, such as the superconducting coil 228. In still other embodiments, a switch may be connected at other different locations along the superconducting current path 220. The ability to use a switch at nearly any location within the superconducting current path 220 allows for greater design flexibility and to design for portions of a superconducting current path that are not sufficiently robust or reliability for the specified or desired time period for typical operating states.

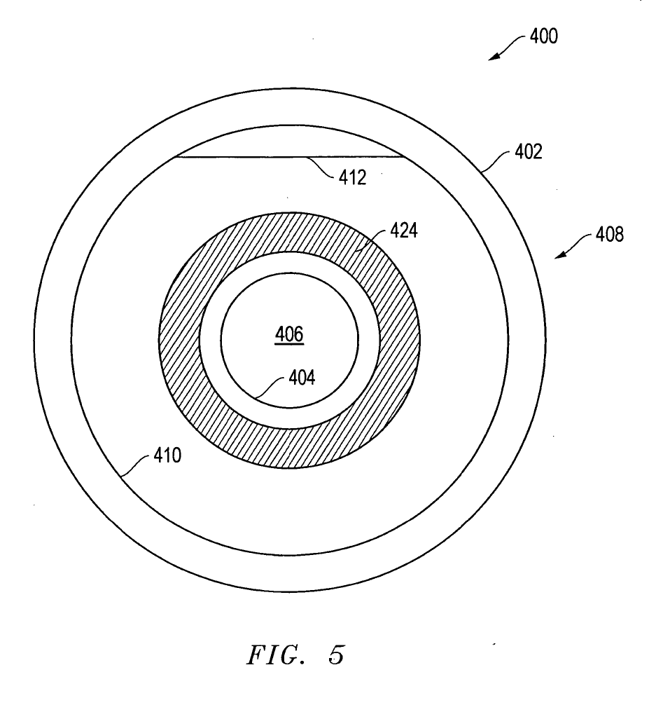

Attention is now directed to FIGS. 4 and 5 that include cross-sectional schematic illustrations of a system 400 as seen from a side view and an end view, respectively. FIG. 5 includes the cross-sectional illustration at sectioning line 5-5 in FIG. 4. In one embodiment, the system 400 can be an MRI system and have the circuit configuration as described with respect to FIG. 2. The system 400 can include a cover 408 that includes an outer portion 402 and an inner portion 404. An analyzing region 406 is disposed within an opening defined by the inner portion 404 of the cover 408. The system also includes a vessel 410 that can include a liquid cryogen filled to the level 412 in FIG. 4. The liquid cryogen surrounds the superconducting elements. For example the liquid cryogen can completely surround the superconducting elements (FIGS. 4 and 5) or may only partially surround a superconducting element (not illustrated). The vessel 410 can also be called a cryostat. Although not illustrated, the system 400 may also include an additional wall or other division (e.g., a thermal shield) to provide insulation or further mechanical support. FIG. 5 includes a cross-sectional view as seen from an end of the system 400.

In one embodiment, a persistent current switch 422, superconducting coils 424, 426, and 428, and nodes 482 and 484 (illustrated by dashed ovals) are disposed within the vessel 410. The persistent current switch 422 can be any of the configurations as described with respect to the persistent current switch 222 in FIG. 2. The superconducting coils 424, 426, and 428 and the nodes 482 and 484 are physical embodiments of the superconducting coils 224, 226, and 228, and nodes 282 and 284, respectively, of the circuit diagram in FIG. 2. Although not illustrated, the persistent current switch 422 includes a control terminal to allow the persistent current switch 422 to allow for control of the persistent current switch 422 outside of the vessel 410. The system 400 can also include power supply terminals 442 and 444 and a switch 462, which are physical embodiments of the power supply terminals 242 and 244 and the switch 262, respectively, of the circuit diagram in FIG. 2. Although not illustrated, more or fewer superconducting coils or persistent current switches, another superconducting element, a control sub-system, another sub-system, or any combination thereof may also be used.

The switch 462 is designed to be more robust and reliable compared to the persistent current switch 464. In one embodiment, the switch 462 includes a portion that is not a superconducting element, and another portion that may or may not include a superconducting element. In a particular embodiment, the switch 462 is designed to have relatively low impedance, including the resistance and inductance of all elements of the switch 462 and their contact resistance when in its lower impedance state, however, even when in its lower impedance state, the resistance through the switch 462 is significantly higher than zero ohms. In one embodiment, the switch 462 may have a resistance of at least 10⁻⁶ Ohms when in its lower impedance state. In another embodiment, any detectible resistance may be considered significant when used with a superconducting element. Therefore, even when the switch 462 is in its lower impedance state, the impedance through the switch 462 can be at least 10 times higher than the impedance through persistent current switch 422 when in its lower impedance state. In a more particular embodiment, the impedance through the switch 462 when in its lower impedance state can be at least 100, 200 or 1000 times higher than the impedance through the persistent current switch 422 when in its lower impedance state.

In one embodiment, the switch 462 comprises a mechanical switch including terminals and a shorting link. In FIG. 4, the switch 462 has a terminal 4622 coupled to the node 482, and a terminal 4624 coupled to the node 484. In a particular embodiment, the terminals 4622 and 2624 are connected to nodes 482 and 484, respectively. The switch 462 includes a control element 4626, which in a particular embodiment, is also a shorting link. When the switch 462 is in its higher impedance state, the control element 4626 does not contact the terminal 4622, the terminal 4624, or both. The higher impedance state of the switch 462 can correspond to an open circuit with respect to the switch 462. When the switch 462 is in its lower impedance state, the control element 466 contacts the terminals 4622 and 4624, and the lower impedance state corresponds to a closed circuit with respect to the switch 462. The switch 462 can include a knife switch, a MULTILAM™ brand connector, a terminal-and-post configuration, an electromechanical relay, or the like.

The connections within the switch 462 may be treated to provide low contact resistance. Such treatments can include polishing, gold plating, CuNi plating, tinning with solders (superconducting, or non-superconducting), another suitable contact resistance lowering treatment, or any combination thereof The connection between the terminals and the shorting link can use relatively smooth interfaces, screw threads, or the like. The shorting link can be straight sided, tapered, or any combination thereof. In yet another embodiment, the switch 462 can have a shorting receptacle that includes the terminals 4622 and 4624. The shorting receptacle and the shorting link (e.g., control element 4626) can be substantially circular, oval, rectangular, or another suitable shape that can be designed a low resistance contact between the shorting receptacle and the shorting link. The shorting link can be one object or a combination of elements that are electrically connected to provide sufficiently low resistance. In still another embodiment, the switch 462 may include a heater that enables hot solder to connect the shorting link to the terminals of the switch, disconnect the shorting link from a terminal of the switch, or both. The heater may be permanently installed or removable.

In another embodiment (not illustrated), the switch 462 can include a shorting link portion and a resistive portion. When the shorting link portion is connected or otherwise active, the switch 462 is in its lower impedance state, as previously described. When the resistive portion is connected or otherwise active, the switch 462 is in its higher impedance state, and as compared to its lower impedance state, the impedance through the switch 462 when in its higher impedance state can be at least 3, 6, or more orders of magnitude higher than the impedance through the switch 462 when in its lower impedance state. In one embodiment, the switch 462 can include a resistive portion that can, for example, be made active without mechanical linking by heating a superconducting element that is part of the switch 462. The external power supply terminals 452 and 454 may or may not be part of the system 400.

The actual location of some of the components can be varied. As illustrated in FIG. 4, the power supply terminals 442 and 444 are disposed within the vessel 410. In this embodiment, part or all of the external power supply terminal 452 may extend or otherwise be inserted into the vessel 410 when the external power supply terminal 452 is connected or otherwise coupled to the power supply terminal 442. In this embodiment, part or all of the external power supply terminal 454 may extend or otherwise be inserted into the vessel 410 when the external power supply terminal 454 is connected or otherwise coupled to the power supply terminal 444. In another embodiment (not illustrated), the power supply terminal 442, the power supply terminal 444 or both may be disposed outside the vessel 410.

As illustrated in FIG. 4, the terminals 4622 and 4624 of the switch 462 are disposed within the vessel 410. In this embodiment, part or all of the control element 4626 may extend or otherwise be inserted into the vessel 410 when the switch 462 is in its lower impedance state. In another embodiment (not illustrated), the terminal 4622, the terminal 4624 or both may be disposed outside the vessel 410.

Although not illustrated, the system 400 can include ports (not illustrated) that allow the external power supply terminal 452, the external power supply terminal 454, the control element 4626, or any combination thereof to be inserted through the cover 408 and through a wall of the vessel 410. One or all of the ports may be sealed or otherwise closed during different states. For example, when the system 410 is in its typical operating state, the control element 4626 may extend through its corresponding port, whereas ports corresponding to the power supply terminals 442 and may be sealed or otherwise closed. After reading this specification, skilled artisans will understand how to physically and electrically configure the system 400 to meet their needs or desires.

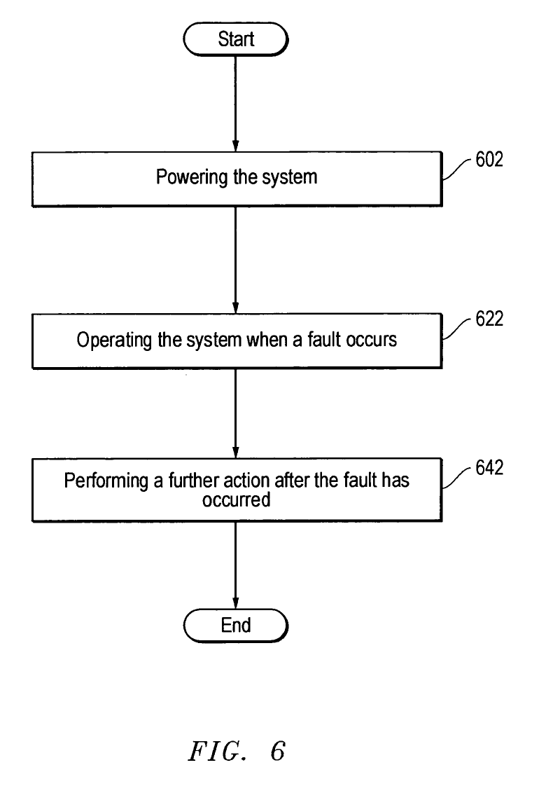

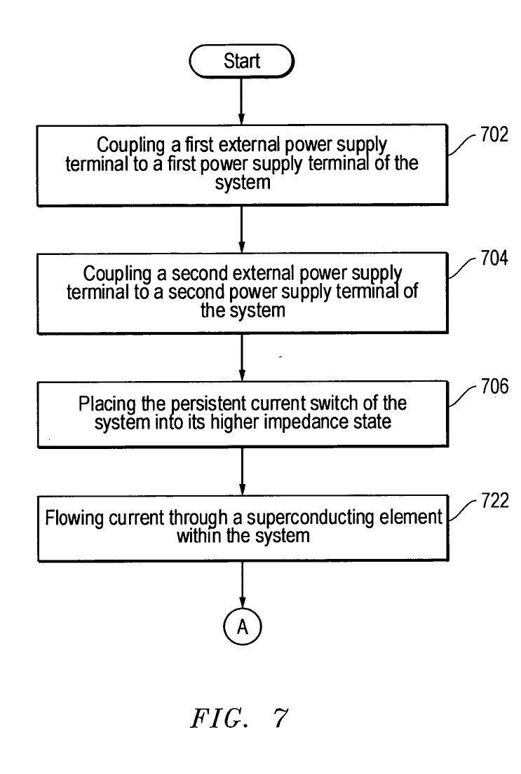

Attention is now directed to methods of using the systems. The method will be described in FIGS. 6-9 with reference to FIG. 4. FIG. 6 includes a general description of a method that is described with respect to a particular embodiment in FIGS. 7-9. Referring to FIG. 6, method can include powering the system, at block 602, operating the system when a fault occurs, at block 622, and performing a further action after the fault has occurred, at block 642.

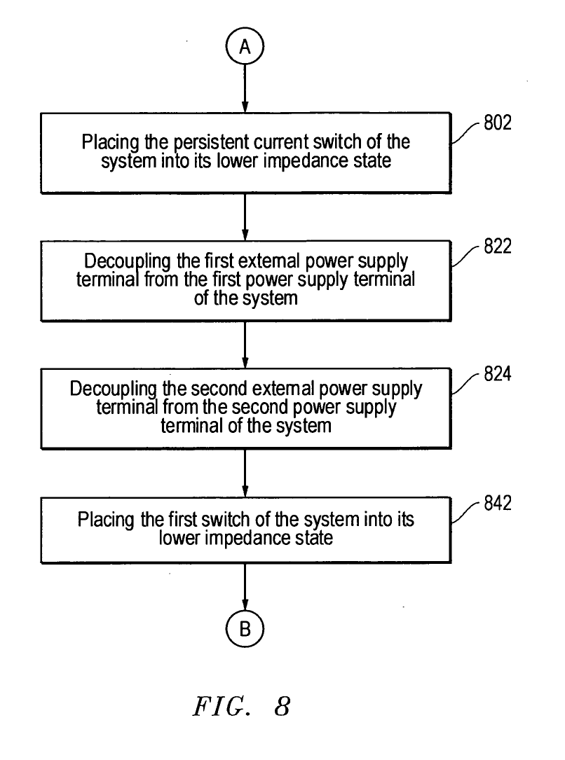

Powering the system can be performed using the actions in FIGS. 7 and 8. The method can include coupling a first external power supply terminal to a first power supply terminal of the system, at block 702 of FIG. 7, and coupling a second external power supply terminal to a second power supply terminal of the system, at block 704. Referring to FIG. 4, in one embodiment, the external power supply terminal 452 is connected to the power supply terminal 442, and the external power supply terminal 454 is connected to the power supply terminal 444. The method can further include placing the persistent current switch of the system into its higher impedance state, at block 706 of FIG. 7. As used in this specification, placing refers to changing a circuit element or other object to a desired state from another state or checking or otherwise ensuring that the circuit element or object is in its desired state (i.e., changing states may not be required). Referring to FIG. 4, the control element within the persistent current switch 422 can be activated. If the control element is a resistive heating element, current flows through the resistive heating element to provide heat. The heat may substantially prevent the superconducting element from being in its superconducting state. Also, the method can include placing the switch 462 in its higher impedance state, if the switch 462 is not already in its higher impedance state. More specifically, the control element 4626 does not contact one or both of the terminals 4622 and 4624.

The method can further include flowing current through a superconducting element within the system, at block 722 of FIG. 7. Current can flow through one of the external power supply terminals (452, 454), through its corresponding power supply terminal (442, 444), through the superconducting coils 424, 426, and 428, though the other of the power supply terminal (442, 444), and through the other external power supply terminal (452, 454). No significant current flows through the persistent current switch 422 and the switch 462. The current flow is maintained until the superconducting coils are at a specified or desired magnetic field.

The method can still further include placing the persistent current switch of the system into its lower impedance state, at block 802 in FIG. 8. In a particular embodiment, the control element within the persistent current switch 422 in FIG. 4 can be deactivated. If the control element is a resistive heating element, current no longer flows through the resistive heating element, and therefore, no further heat is provided by the resistive heating element. The superconducting element of the persistent current switch 422 cools and eventually reaches its superconducting state. The superconducting current path includes the persistent current switch 422 and the superconducting coils 424, 426, and 428 and has substantially zero resistance, as all superconducting elements are in their superconducting states.

The method can yet further include decoupling the first external power supply terminal from the first power supply terminal of the system, at block 822 in FIG. 8, and decoupling the second external power supply terminal from the second power supply terminal of the system, at block 824. Referring to FIG. 4, in one embodiment, the external power supply terminal 452 is disconnected from the power supply terminal 442, and the external power supply terminal 454 is disconnected from the power supply terminal 444.

The method can also include placing the first switch of the system into its lower impedance state, at block 842 of FIG. 8. In a particular embodiment, the switch 462 of FIG. 4 can be placed into its lower impedance state by moving the control element 4626 so that the control element 4626 contacts both of the terminals 4622 and 4624. The timing for placing the first switch into its lower impedance state can be varied. For example, the placement may be performed before decoupling either or both of the external power supply terminals. At this time, the system is in its typical operating state. Although the switch 462 is in its lower impedance state, no significant current flows through the switch 462 because the persistent current switch 422 has substantially no resistance.

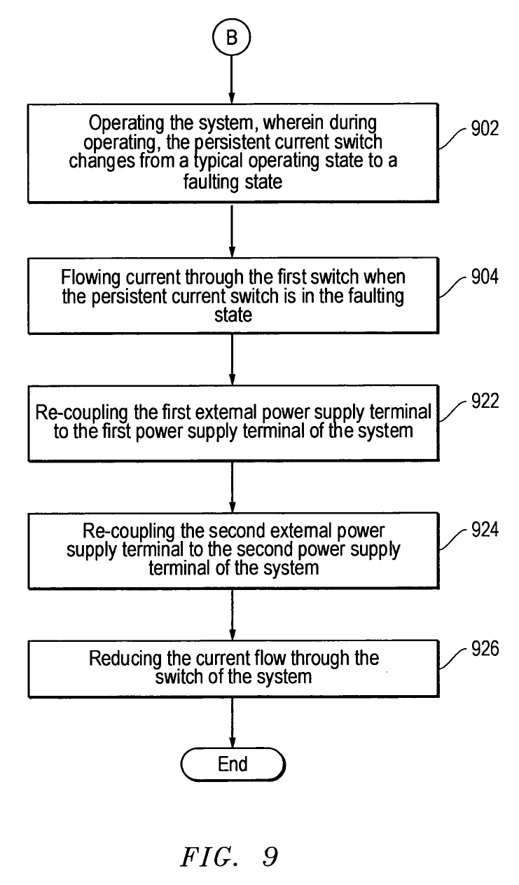

The method can further include operating the system, wherein during operating, the persistent current switch changes from a typical operating state to a faulting state, at block 902 of FIG. 9.

After the persistent current switch changes from a typical operating state to a faulting state, the method can include flowing current through the first switch when the persistent current switch is in the faulting state, at block 904. Referring to FIG. 4, when the persistent current switch 422 is in its faulting state, it is not operating as a superconducting element. The current path through the switch 462 can have lower resistance than the persistent current switch 422, and therefore, a significant amount of current now flows through the switch 462. In a particular embodiment, substantially all of the current flows through the switch 462. When the switch 462 is used and in its lower impedance state, a longer time may elapse before substantially all of the liquid cryogen in the vessel 410 boils off, and thus, delay the time before the magnetic field is lost, as compared to the system 400 if the switch 462 were not present. The time period before substantially all liquid cryogen boils off varies; however, the time period may be at least six hours, one day, two days, five days, or potentially even longer. This time period can allow for a qualified service technician to be dispatched and reach the system 400 before substantially all of the liquid cryogen within the vessel 410 boils off, thus, potentially avoiding a substantially complete loss of magnetic field.

After the faulting state occurs and current flows through the switch 462, the next action can vary depending on the state of the system 400, nature of the problem, another factor, or any combination thereof. In one embodiment, the system 400 may be taken to substantially zero magnetic field. The method can include re-coupling the first external power supply to the first power supply terminal of the system, at block 922 of FIG. 9 and re-coupling the second external power supply to the second power supply terminal of the system, at block 924. Referring to FIG. 4, in one embodiment, the external power supply terminal 452 is reconnected to the power supply terminal 442, and the external power supply terminal 454 is reconnected to the power supply terminal 444. At this time, both the persistent current switch 422 and the switch 462 can be placed into their higher impedance states, if this has not yet occurred. The method can also include reducing the current flow through the switch of the system, at block 926 of FIG. 9. In one embodiment, the switch can be switch 462. In a particular embodiment, the current may be reduced to substantially zero amperes, which also reduces the magnetic field to substantially zero. At this time, the qualified service technician may be able to access components within vessel 410, such as the persistent current switch 422. In another embodiment, the method can also include reducing the current flow through the superconducting element (e.g., persistent current switch 422, superconducting coils 424, 426, 428, another suitable superconducting element, or any combination thereof) within the system 400. Reducing the current flow may or may not be performed simultaneously during a point in time when the persistent current switch 422 is in the faulting state.

In another embodiment, current can be increased in the superconducting element to place the system in a pre-faulting state. Alternatively, current flowing through the switch 462 can be monitored to determine current flow through the switch 462 as a function of time. The operating data may be used to detect low-level, intermittent problems may be more quickly. For example, the current flow through the switch 462 should be negligible except for when the persistent current switch 422 is in a faulting date. The operating data may indicate that the current flow persistent current switch 422 at the specified or desired level occurs nearly all the time but occasionally varies. By monitoring current through switch 462, a qualified service technician may determine that the connections at the terminals of the persistent current switch 422 should be examined.

Other actions may be performed and may not require the system 400 to be taken to substantially zero magnetic field.

After reading this specification, skilled artisans will appreciate that the concepts described herein are not limited to a particular MRI system, such as a cylindrical MRI system, as illustrated in FIGS. 4 and 5. For example, the concepts can be extended to an open MRI system. The concepts can be extended to nearly any system or sub-system, particularly where reliability of a superconducting element or another portion of the system or sub-system is in sufficient. In another application, the system or sub-system may include a transmission or distribution cable, a transformer, a fault current limiter, one or more other suitable electronic devices, or any combination thereof.

After reading this specification, skilled artisans will appreciate that use of a more robust and reliable switch can allow for a longer time period before a system boils off substantially all of its liquid cryogen. The longer time period can allow for a qualified service technician to be dispatched and reach a remote location where the system is located. The qualified service technician can diagnose the system or perform other actions that may prevent quenching, reduce further damage to the system, reduce the amount of liquid cryogen lost, reduce the necessity of taking the system to substantially zero magnetic field, reduce the likelihood of another undesired consequence, or any combination thereof.

Many different aspects and embodiments are possible. Some of those aspects and embodiments are described below. After reading this specification, skilled artisans will appreciate that those aspects and embodiments are only illustrative and do not limit the scope of the present invention.

In a first aspect, a circuit can include a superconducting current path and a first switch having a first terminal and a second terminal. The first switch can be connected in parallel with a portion of the superconducting current path. The first terminal can be connected to the superconducting current path at a first node, and the second terminal is connected to the superconducting current path at a second node, wherein the second node is different from the first node.

In one embodiment of the first aspect, the superconducting current path can include a persistent current switch that includes a first superconducting element. In a particular embodiment, the first superconducting element can have a third terminal and a fourth terminal, wherein the third terminal of the first superconducting element is connected to the first node, and the fourth terminal of the first superconducting element is connected to the second node. In a more particular embodiment, the first switch and the persistent current switch can be configured such that when the first switch would be in a first lower impedance state and the persistent current switch would be in a second lower impedance state, the first switch would have a higher impedance as compared to the persistent current switch.

In another particular embodiment of the first aspect, the superconducting current path can further include a second superconducting element. In a more particular embodiment, a superconducting coil can include a third terminal and a fourth terminal, wherein the third terminal of the superconducting coil is coupled to the first node, and the fourth terminal of the superconducting coil is coupled to the second node. In an even more particular embodiment, the first switch can be connected to the superconducting coil at a location other than the third terminal or the fourth terminal.

In a second aspect, a system can include a first superconducting element including a first terminal and a second terminal, and a first switch including a third terminal and a fourth terminal, wherein the first switch is not a persistent current switch. The third terminal can be coupled to a first terminal of the first superconducting element, and the fourth terminal can be coupled to a second terminal of the first superconducting element.

In one embodiment of the second aspect, the first superconducting element can be a superconducting coil. In another embodiment, the system can further include a first power supply terminal coupled to the first terminal of the superconducting element, a second power supply terminal coupled to the second terminal of the superconducting element, and a persistent current switch can include a fifth terminal and a sixth terminal, wherein the fifth terminal is coupled to the first power supply terminal, and the sixth terminal is coupled to the second power supply terminal. In a particular embodiment, the persistent current switch and the first switch are connected in parallel. In another particular embodiment, the persistent current switch can include a second superconducting element and a control element. In a more particular embodiment, the control element can include a heating element that is configured to be active when the persistent current switch would be in a higher impedance state and is configured to not be active when the persistent current switch would be in a lower impedance state.

In a further particular embodiment of the second aspect, the first switch and the persistent current switch can be configured such that when the first switch would be in a first lower impedance state and when the persistent current switch would be in a second lower impedance state, the first switch would have a higher impedance as compared to the persistent current switch. In still a further embodiment, the first terminal of the first superconducting element can be coupled to the third terminal of the first switch and the fifth terminal of the persistent current switch, and the second terminal of the first superconducting element can be coupled to the fourth terminal of the first switch and the sixth terminal of the persistent current switch.

In a further embodiment of the second aspect, the first switch can include a mechanical switch. In still a further embodiment, the first switch can be connected to the first superconducting element at a location other than the first terminal or the second terminal. In yet a further embodiment, the system can further include a liquid cryogen that surrounds the first superconducting element.

In a third aspect, a method of using a system can include coupling a first external power supply terminal to a first power supply terminal of the system, coupling a second external power supply terminal to a second power supply terminal of the system, and flowing current through a superconducting element within the system when the first external power supply terminal to the first power supply terminal of the system and the second external power supply terminal to the second power supply terminal of the system. The method can also include placing a persistent current switch of the system into a first lower impedance state, decoupling the first external power supply terminal from the first power supply terminal of the system, decoupling the second external power supply terminal from the second power supply terminal of the system, and placing a first switch of the system into a second lower impedance state.

In one embodiment of the third aspect, the method can further include operating the system, wherein during operating, the persistent current switch changes from a typical operating state to a faulting state, and flowing current through the first switch when the persistent current switch is in the faulting state. In a particular embodiment, the method can further include re-coupling the first external power supply to the first power supply terminal of the system, re-coupling the second external power supply to the second power supply terminal of the system, and reducing the current flow through the first switch of the system after re-coupling the first external power supply to the first power supply terminal of the system and re-coupling the second external power supply to the second power supply terminal of the system and before substantially all liquid cryogen or magnetic field loss occurs.

Note that not all of the activities described above in the general description or the examples are required, that a portion of a specific activity may not be required, and that one or more further activities may be performed in addition to those described. Still further, the order in which activities are listed is not necessarily the order in which they are performed.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that a structural substitution, logical substitution, or another change may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed subject matter requires more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

It is to be appreciated that certain features are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A circuit comprising:
a superconducting current path; and
a first switch including a first terminal and a second terminal, wherein:
the first switch is connected in parallel with a portion of the superconducting current path;
the first terminal is connected to the superconducting current path at a first node; and
the second terminal is connected to the superconducting current path at a second node, wherein the second node is different from the first node.

2. The circuit of claim 1, wherein the superconducting current path comprises a persistent current switch that includes a first superconducting element.

3. The circuit of claim 2, wherein the first superconducting element has a third terminal and a fourth terminal, wherein:
the third terminal of the first superconducting element is connected to the first node; and
the fourth terminal of the first superconducting element is connected to the second node.

4. The circuit of claim 3, wherein the first switch and the persistent current switch are configured such that when the first switch would be in a first lower impedance state and the persistent current switch would be in a second lower impedance state, the first switch would have a higher impedance as compared to the persistent current switch.

5. The circuit of claim 2, wherein the superconducting current path further comprises a second superconducting element.

6. The circuit of claim 5, wherein the second superconducting element comprises a superconducting coil having a third terminal and a fourth terminal, wherein:
the third terminal of the superconducting coil is coupled to the first node; and
the fourth terminal of the superconducting coil is coupled to the second node.

7. The circuit of claim 6, wherein the first switch is connected to the superconducting coil at a location other than at the third terminal or the fourth terminal.

8. A magnetic resonance imaging system comprising the circuit of claim 1.

9. A system comprising:
a first superconducting element including a first terminal and a second terminal; and
a first switch including a third terminal and a fourth terminal, wherein:
the first switch is not a persistent current switch;
the third terminal is coupled to a first terminal of the first superconducting element; and
the fourth terminal is coupled to a second terminal of the first superconducting element.

10. The system of claim 9, further comprising:
a first power supply terminal coupled to the first terminal of the superconducting element;
a second power supply terminal coupled to the second terminal of the superconducting element; and
a persistent current switch including a fifth terminal and a sixth terminal, wherein:
the fifth terminal is coupled to the first power supply terminal; and
the sixth terminal is coupled to the second power supply terminal.

11. The system of claim 10, wherein the persistent current switch and the first switch are connected in parallel.

12. The system of claim 10, wherein the persistent current switch includes a second superconducting element and a control element.

13. The system of claim 12, wherein the control element includes a heating element that is configured to be active when the persistent current switch would be in a higher impedance state and is configured to not be active when the persistent current switch would be in a lower impedance state.

14. The system of claim 10, the first switch and the persistent current switch are configured such that when the first switch would be in a first lower impedance state and when the persistent current switch would be in a second lower impedance state, the first switch would have a higher impedance as compared to the persistent current switch.

15. The system of claim 10, wherein:
the first terminal of the first superconducting element is coupled to the third terminal of the first switch and the fifth terminal of the persistent current switch; and
the second terminal of the first superconducting element is coupled to the fourth terminal of the first switch and the sixth terminal of the persistent current switch.

16. The system of claim 9, wherein the first switch includes a mechanical switch.

17. The system of claim 9, wherein the first switch is connected to the first superconducting element at a location other than the first terminal or the second terminal.

18. The system of claim 9, further comprising a liquid cryogen that surrounds the first superconducting element.

19. The system of claim 9, wherein the system comprises a magnetic resonance imaging system.

20. A method of using a system comprising:
coupling a first external power supply terminal to a first power supply terminal of the system;
coupling a second external power supply terminal to a second power supply terminal of the system;
flowing current through a superconducting element within the system when the first external power supply terminal to the first power supply terminal of the system and the second external power supply terminal to the second power supply terminal of the system;
placing a persistent current switch of the system into a first lower impedance state;
decoupling the first external power supply terminal from the first power supply terminal of the system;
decoupling the second external power supply terminal from the second power supply terminal of the system; and
placing a first switch of the system into a second lower impedance state.

21. The method of claim 20, further comprising:
operating the system, wherein during operating, the persistent current switch changes from a typical operating state to a faulting state; and
flowing current through the first switch when the persistent current switch is in the faulting state.

22. The method of claim 21, further comprising:
re-coupling the first external power supply to the first power supply terminal of the system;
re-coupling the second external power supply to the second power supply terminal of the system; and
reducing the current flow through the first switch within the system after re-coupling the first external power supply to the first power supply terminal of the system and re-coupling the second external power supply to the second power supply terminal of the system and before substantially all liquid cryogen or magnetic field loss occurs.

23. The method of claim 20, wherein the system comprises a magnetic resonance imaging system.
